(19) United States
(12) Patent Application Publication
(10) Pub. No.: US 2016/0147211 A1
(43) Pub. Date: May 26, 2016

(54) METHODS, SYSTEMS, AND DEVICES FOR CONFIGURING FACILITY SYSTEM DEVICES

(71) Applicant: Honeywell International Inc., Morristown, NJ (US)

(72) Inventors: Vinayak Sadashiv Kore, Bangalore (IN); Sindhu Sondur, Bangalore (IN)

(21) Appl. No.: 14/553,558

(22) Filed: Nov. 25, 2014

(51) Int. Cl. G05B 19/042; H04W 4/00

(52) U.S. Cl. CPC G05B 19/0426; H04W 4/008; G05B 2219/25124; G05B 2219/23258; G05B 2219/25112

(57) ABSTRACT

Devices, methods, and systems for configuring facility system devices are described herein. One method includes establishing a wireless connection between a mobile device and a facility system device, receiving operating information at the mobile device from the facility system device via the wireless connection, displaying a menu associated with configuring the facility system device based on the operating information via the mobile device, and configuring the facility system device based on a user input made using the displayed menu.

### TECHNICAL FIELD

The present disclosure relates to methods and systems for configuring facility system devices.

### BACKGROUND

Facilities, such as buildings, homes, plants, hospitals, refineries, etc. may have many systems installed within them. For example, facilities can include access control systems, security systems, alarm systems, heating, ventilation, and air conditioning (HVAC) systems, and others. Those systems may be made up of a variety of system devices. A short list of such devices may include, for example, gateway devices, alarms, sensors, ducts, cameras, and card readers, among others. In order for the devices, and therefore the facility systems, to operate properly, the devices may be configured at installation and/or during scheduled maintenance operations, among other times.

Those that configure facility system devices using previous approaches may encounter difficulties arising from limited user interfaces on the devices. For example, some devices may include only mechanical switches, keyboards, light emitting diodes (LEDs), or size-restricted displays. With the limited information provided by such interfaces, users may find it difficult to configure system devices and/or may configure system devices incorrectly. What is more, approaches that use LEDs may be an annoyance to occupants of the facility because the LEDs may incessantly blink, for instance.

Additionally, previous approaches may involve multiple users: one to interact with the device itself, and another to view its corresponding configuration status using a separate (e.g., remote) user interface, such as a facility monitoring panel. Costs to configure system devices may increase with the number of users tasked with configuring the system devices. Further, searching for and/or locating devices using device addresses under previous approaches may be time consuming and may disturb occupants during the search.

Because of the difficulties presented by previous approaches, device updates (e.g., firmware upgrades) may lag in the facility. Resulting delays in development cycle and/or new product introduction may cause reductions in revenues for the facility and/or its owners.

### BRIEF DESCRIPTION OF THE DRAWINGS

FIG. 1 illustrates a system for configuring facility system devices in accordance with one or more embodiments of the present disclosure.

FIG. 2 illustrates another system for configuring facility system devices in accordance with one or more embodiments of the present disclosure.

FIG. 3 illustrates a method for configuring facility system device in accordance with one or more embodiments of the present disclosure.

### DETAILED DESCRIPTION

Methods and systems for configuring facility system devices are described herein. For example, one or more embodiments include establishing a wireless connection between a mobile device and a facility system device, receiving operating information at the mobile device from the facility system device via the wireless connection, displaying a menu associated with configuring the facility system device based on the operating information via the mobile device, and configuring the facility system device based on a user input made using the displayed menu.

Facility system devices can be configured in accordance with one or more embodiments of the present disclosure through the use of a mobile device (e.g., smartphone, personal digital assistant (PDA), tablet, etc.) that communicates with the facility system devices. By employing a mobile device, embodiments of the present disclosure can provide a more robust user interface (e.g., via a mobile application) and/or display than may have been available under previous approaches. Instead of interpreting various blinking patterns of LEDs, for instance, users can be provided with device status and/or supporting information in readily understandable ways.

To enable communication between mobile devices and facility system devices, embodiments of the present disclosure may utilize passive near field communication (NFC) tags in the devices, for instance, though other means of communication (discussed below) are also in accordance with one or more embodiments.

Configuring facility system devices, as referred to herein, can include determining information regarding facility system devices (and their associated network(s) and/or changing a status (e.g., a configuration status) of facility system devices (and their associated networks). For example, configuring can include assigning and/or allocating addresses to devices, determining settings, activating and/or deactivating devices, adjusting device and/or network settings, testing devices, testing networks, determining errors in devices and/or networks, upgrading device firmware, etc.

For example, embodiments of the present disclosure can enable users to assign and/or allocate addresses (e.g., alphabetic, numerical and/or alphanumerical identifiers) to devices using a mobile device. Embodiments of the present disclosure can enable users to test devices on site (e.g., at the location of the device) and therefore obviate the need for a second (or additional) user at a user interface (e.g., a control panel). Further, embodiments of the present disclosure can allow firmware upgrades to be distributed to devices using the mobile device.

In some embodiments, location functionalities of the mobile device can be utilized to navigate a user to a particular device. Navigating directly to the device can allow users to save time and cost associated with searching for the device as may have been the case under previous approaches.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing. Similar elements or components between different figures may be identified by the use of similar digits.

As used herein, “a” or “a number of” something can refer to one or more such things. For example, “a number of options” can refer to one or more options.

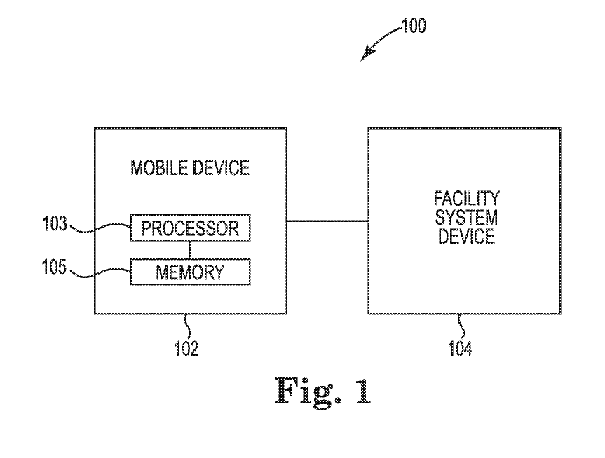

FIG. 1 illustrates a system 100 for configuring facility system devices in accordance with one or more embodiments of the present disclosure. As shown in FIG. 1, system 100 includes a mobile device 102 and a facility system device 104. The facility system device 104 can be a device of a facility system, for instance.

For example, the facility system device 104 can be a part of a access control system, video system, communications system, notification system, fire alarm system, elevator system, chemical, biological, radiological, and nuclear (CBRN) defense system, biometric systems, geographical information system (GIS), heating, ventilation, and air conditioning (HVAC) system, automated bollard system, building management system, air purging system, radio frequency identification system, etc., though embodiments of the present disclosure are not so limited.

The facility system device 104 can be a device for providing one or more aspects of comfort in the facility. For example, the facility system device can be a heating, ventilation, and air condition (HVAC) device, (e.g., a thermostat, duct controller, air handling unit (AHU), etc.), a sensing device (e.g., humidity and/or temperature sensor), a security device (e.g., an access card reader and/or security camera), and/or a safety device (e.g., a smoke detector), among others.

The mobile device 102 can be, for example, a laptop computer, a mobile phone (e.g., smartphone), a personal digital assistant, a tablet, etc., among other types of computing devices. As shown in FIG. 1, the mobile device 102 includes a memory 105 and a processor 103 coupled to memory 105. Memory 105 can be any type of storage medium that can be accessed by processor 103 to perform various examples of the present disclosure. For example, memory 105 can be a non-transitory computer readable medium having computer readable instructions (e.g., computer program instructions) stored thereon that are executable by processor 103 to configure the facility system device 104 in accordance with one or more embodiments of the present disclosure.

Memory 105 can be volatile or nonvolatile memory. Memory 105 can also be removable (e.g., portable) memory, or non-removable (e.g., internal) memory. For example, memory 105 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical disk storage, and/or a magnetic medium such as magnetic cassettes, tapes, or disks, among other types of memory.

Further, although memory 105 is illustrated as being located in mobile device 102, embodiments of the present disclosure are not so limited. For example, memory 105 can also be located internal to another computing resource (e.g., enabling computer readable instructions to be downloaded over the Internet or another wired or wireless connection).

The mobile device 102 can establish a wireless connection with the facility system device 104 and can wirelessly communicate with the facility system device 104. Upon establishment of the wireless connection, embodiments of the present disclosure can configure the facility system device 104 using the mobile device 102.

In some embodiments, the facility system device can include a passive NFC tag (sometimes generally referred to as “tag”). The tag can be a part of the printed circuit board (PCB) of the facility system device 104. The tag can be interfaced to device electronics using one or more serial interfaces, such as serial peripheral interface (SPI), inter-integrated circuit (I2C), and/or universal asynchronous receiver/transmitter (UART), for example. The tag can include a number of bytes of static memory, for instance, which can be accessed by the mobile device 102 by activating the tag and/or by a processor of the facility system device using serial and/or parallel interfaces.

In some embodiments, the tag can be configured to activate (e.g., “wake up”) and/or interrupt a controller (e.g., microcontroller) of the facility system device 104 responsive to a signal from the mobile device 102. The tag can support a pass-through mode, where, when activated by the mobile device 102, information can be exchanged between the facility system device 104 and the mobile device 102 via the tag.

In some embodiments, communication between the mobile device 102 and the facility system device 104 can be carried out via the use of one or more radio-frequency identification (RFID) tags in place of, or in addition to, the NFC tag. In some embodiments, communication between the mobile device 102 and the facility system device 104 can be carried out via the use of a radio such as Bluetooth low energy (BLE) and/or Wi-Fi, among other radios.

As previously discussed, some embodiments may utilize an NFC tag in the facility system device 104. The tag can store a status of the device (e.g., a configuration status) and supporting information. The status and/or the supporting information may be referred to herein as “operating information.” An application running on the mobile device 102 (e.g., executed instructions) can activate the tag and read the status of the facility system device 104.

The operating information can be displayed to the user via a display of the mobile device 102. Displays in accordance with one or more embodiments of the present disclosure can include liquid crystal displays (LCDs), light emitting diodes (LEDs), and/or plasma displays, among others. In other embodiments, discussed further below, the status of the facility system device 102 can be communicated aurally (e.g., as audio) to the user by the mobile device 102 in addition to, or in place of, communication by the display.

Embodiments of the present disclosure can receive and/or determine the operating information associated with the facility system device 104 without powering up the facility system device 104 and/or activating a controller (e.g., a microcontroller) of the facility system device 104. That is, the tag can be read by the mobile device 102 when the facility system device is not powered. Accordingly, embodiments of the present disclosure can receive operating information from facility system devices may be misconfigured, bricked, corrupted, and/or dead.

In other embodiments, the tag can be used in a pass-through mode where the mobile device 102 can communicate directly with a controller of the facility system device upon activation of the tag by the mobile device 102. Communication with the controller can allow the mobile device 102 to receive operating information associated with the device and/or debug an error state associated with the facility system device 104.

Upon receiving the operating information the user can view the operating information via the display of the mobile device 102 and/or hear the operating information via a sound-producing portion of the mobile device 102 (e.g., speaker, headphones, etc.).

Displaying the operating information can include displaying a menu associated with configuring the facility system device 104 based on the operating information. The menu can include a number of options for configuring the facility system device 104. Options can include assigning and/or allocating an address to the facility system device 104, activating and/or deactivating the facility system device 104, adjusting one or more settings of the facility system device 104, testing the facility system device 104, determining one or more errors associated with the facility system device 104, upgrading a firmware of the facility system device 104, etc.

The user can make one or more inputs into the mobile device 102 associated with configuring the mobile device 102. The inputs can be made using a keyboard and/or touchscreen keyboard of the mobile device 102, though embodiments of the present disclosure are not limited to a particular manner of making inputs. For example, in some embodiments, inputs may be made by voice command using an audio-capturing functionality (e.g., microphone) of the mobile device 102 and speech recognition may be employed. In some embodiments, a user input may include the user selecting an icon labeled “configure” on the display of the mobile device 102.

Embodiments of the present disclosure can allocate and/or assign addresses (e.g., identifiers) to facility system devices. For example, the mobile device 102 can prompt the user to input an address to be assigned to the facility system device 104. Upon receiving the input, the mobile device can perform one or more error checks on the input address, such as a check for a duplicate address, a repeated address, and/or a zero address, for instance. If any errors are found, the mobile device 102 can prompt the user to correct the errors.

In some instances, an installer of the facility system device 104 may be provided with a written list of addresses to assign to facility system devices. Such a list can be displayed on the mobile device 102. The user can select one or more addresses from the list to be assigned to the facility system device 104.

In some instances, locations of facility system devices and/or addresses may be provided in a model (e.g., building information model (BIM)), floor plan and/or map of the facility. Mobile device 102 can determine (e.g., read) an address directly using an imaging functionality, for instance, and assign the determined address to a particular facility system device. In some embodiments, the model can be uploaded to the mobile device 102 as a digital rendering and the user can visualize the digital rendering to indicate what address(es) to assign to which device(s).

During maintenance of the facility, systems of the facility, and/or devices of the systems of the facility, previous approaches may be cumbersome in that the user may need to search for and find the location of a particular device. Embodiments of the present disclosure can navigate the user to a particular device based on the device's address. The user can input the address into the mobile device 102 and/or select the address from a menu.

The address of the device can be associated with the location of the device during installation, for instance, or at another time. Embodiments of the present disclosure can use location and/or navigational functionalities of the mobile device 102 (e.g., GPS, inertial) and/or allow the mobile device 102 to communicate with one or more location beacons in the facility to triangulate and/or trilaterate its position (e.g., via Wi-Fi, RFID, infrared, ultrasound, etc.). Thus, embodiments of the present disclosure can determine a location of the facility system device 104, determine a location of the mobile device 102, and navigate a user of the mobile device 102 to the facility system device 104.

In some instances, device addresses may be determined by an installer using a program (e.g., a software program). Embodiments of the present disclosure can incorporate such a software program such that the device addresses can be received and/or displayed by the mobile device 102. For example, addresses (included in the software program) can be uploaded and/or emailed to the mobile device 102.

Once the facility system device 104 has been configured, the mobile device 102 can update the model indicating the configuration. The model can be stored in the memory 105, for instance. The model can be retrieved responsive to one or more user inputs into the mobile device 102. In some embodiments, the model (e.g., a portion of the model) can be retrieved responsive to the mobile device 102 being located in a particular position within the facility (e.g., within a threshold distance of the facility system device 104).

Configuring the facility system device 104 can include updating a firmware version of the facility system device 104. The pass-through mode, as previously discussed, can additionally be used to upgrade facility system device firmware. For example, the mobile device 102 can determine a type of the facility system device 104 and/or a firmware version from the tag. Then, the mobile device 102 can acquire (e.g., download) another version (e.g., a newer and/or up-to-date version) from an appropriate source (e.g., a registered server). The other (e.g., new) version can be provided to the facility system device 104 via the wireless connection responsive to one or more user inputs.

Configuring the facility system device 104 can include testing the facility system device 104. In previous approaches, facility system devices may have been provided with a separate and/or dedicated button (e.g., switch, magnetic/Hall Effect sensor, etc.) for testing. Embodiments of the present disclosure can obviate the need for such a button by using the NFC tag, for instance, for activation using the mobile device 102, thereby saving cost, space, and/or mechanical design complexity over previous approaches.

In testing the facility system device 104, the facility system device 104 can respond to a test trigger indicating to the mobile device 102 a test status of the facility system device 104. The test trigger can be a stimulus, for instance, selected to determine whether the device is functioning properly. For example, if the facility system device 104 is a smoke/gas detector, a user can spray smoke and/or gas toward the facility system device 104 and/or apply heat (e.g., using a heat gun) to the facility system device 104 as a test trigger. The response of the facility system device 104 can be determined by reading the NFC tag of the facility system device 104 by the mobile device 102 and/or connecting “pass-through” to a controller of the facility system device 104 using the mobile device 102.

A notification regarding the functionality of the facility system device 104 may be provided to the user via the mobile device 102. If the facility system device 104 is determined to be functioning properly, the user can be prompted to acknowledge that functionality. If the facility system device 104 is determined to not be functioning properly, the user can make one or more inputs into the mobile device 102 in order to further configure the facility system device 104.

Configuring the facility system device 104 can include determining a network status of the facility system device 104. As previously discussed, the facility system device 104 can be a part of one or more systems of the facility. As such, the facility system device may be a part of a wired and/or wireless network composed of a plurality of facility system devices. Users may collect operating information from the facility system device, such as history (e.g., join events, drop events, etc), live events, battery events, and other information, in order to ultimately determine whether the network is configured (e.g., installed correctly and/or functioning properly).

In previous approaches, the operating information may be difficult and/or time-consuming for the user to collect because of the limited user interfaces available on facility system devices. Once the operating information is collected, previous approaches may include communicating the information to another user (e.g., an engineer) who can view the information and determine whether the network is configured. In many cases, though, the other user may be remote or possibly in another time zone. As a result, previous approaches may experience time delays and associated costs, especially in cases where the network may benefit from further configuration.

Embodiments of the present disclosure can provide the operating information directly to the user at the time the user is interacting with the facility system device. The user can visualize the operating information and use it to configure the device (e.g., without communicating it to another user and without time delay).

Accordingly the user can be apprised of the status of the network including the battery statuses and/or network participation of devices (e.g., all devices) of the network. The status of the network can be stored on a particular device of the network (e.g., a gateway device), for instance. The status of the network can be displayed on the mobile device 102 in a high-level diagnostic menu, for instance.

The displayed status of the network can include, for example, network stability status, number of devices found in the network, a list of devices participating in the network, a number of devices lost from the network, a list of devices lost from the network, a number of weak links in the network, a list of devices representing the weak links of the network, a number of single links of the network, a list of devices included in the single links of the network, a sync status of the network, an overall device status of the network, a list of devices respectively associated with faulty status, overall battery life, a list of devices respectively associated with faulty battery life, etc.

The user can make one or more inputs into the mobile device 102 in order to determine more detail regarding the status of the network and/or the status of one or more devices of the network. The user can take one or more actions affecting the network using the mobile device 102. For instance, the user can correct errors, if they are present, using the received network status information. The user can select individual devices using the mobile device 102 in order to configure those devices individually.

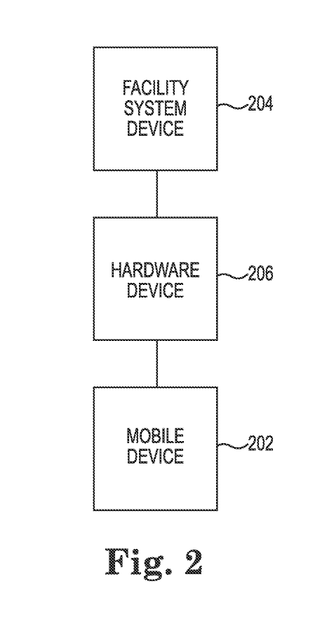

FIG. 2 illustrates another system 206 for configuring facility system devices in accordance with one or more embodiments of the present disclosure. As shown in FIG. 2, system 206 includes a mobile device 202, a hardware device, 206, and a facility system device 204. The mobile device 202 can be analogous to the mobile device 102 (previously described in connection with FIG. 1), and the facility system device 204 can be analogous to the facility system device 104 (previously described in connection with FIG. 1).

The hardware device 206 can be a dongle, for instance. Embodiments of the present disclosure employing the hardware device 206 may be used in instances where the facility system device 204 is installed in a location that may be difficult to access, for instance, though embodiments of the present disclosure are not so limited. For example, in some instances, the facility system device 204 may be installed behind a wall and/or in a ceiling of the facility. The facility system device 204 may be installed such that a user may face difficulty and/or risk injury in attempting to maintain the mobile device 202 within communication range of the facility system device 204 during configuration (e.g., in embodiments where the facility system device 204 includes an NFC tag for communication).

The hardware device 206 can be adapted to be attached (e.g., removably attached) to the facility system device. The attachment can last for the duration of the configuration and then be removed by the user. For example, the hardware device 206 can include a magnetic portion adapted to attach the hardware device 206 to the facility system device 204. The hardware device 206 can include a suction apparatus (e.g., a suction cup) adapted to attach the hardware device 206 to the facility system device 204.

In other embodiments, the hardware device 206 and the facility system device 204 can each include a respective portion adapted to allow the hardware device 206 to be attached to the facility system device 204. For example, the hardware device 206 and the facility system device 204 can each include a respective portion of a hook-and-loop fastening apparatus. In other examples, the respective portions can be portions of a magnetic bracket apparatus, a snap-fit (e.g., plastic) apparatus. Other apparatuses for attaching the hardware device 206 to the facility system device 204, though not specifically listed herein, are in accordance with embodiments of the present disclosure.

Additionally, the hardware device 206 can be attached to one or more other objects at a position proximal to the facility system device 204. The object(s) can include walls, ceilings, floors, other devices, etc. Positions proximal to the facility system device 204 can include positions within a communication range of the facility system device 204 (e.g., positions at which the hardware device 206 can wirelessly communicate with the facility system device 204). The hardware device 206 can be attached at such a position by the methods discussed above, for instance, though embodiments of the present disclosure are not so limited.

The hardware device 206 can be configured to establish a first type of connection with the facility system device 204. The first type of connection can include a connection enabled by the NFC tag of the facility system device 204 (e.g., a short-distance communication). The mobile device 202 can be configured to establish a second type of connection with the hardware device 206. The second type of connection can include a Wi-Fi and/or BLE connection, though embodiments of the present disclosure are not so limited. The second type of connection may be capable of operating at longer ranges than the first type of connection, for instance.

Thus, the hardware device 206 can act as an intermediary allowing the facility system device 204 and the mobile device 202 to exchange information. Accordingly, the hardware device 206 can receive operating information associated with the facility system device 204 from the facility system device 204 via the first type of connection. Then, the mobile device 202 can receive the operating information from the hardware device 206 via the second type of connection.

In a manner analogous to that discussed in connection with FIG. 1, the mobile device 202 can receive an input, made by a user, associated with configuring the facility system device 204, and communicate an indication associated with the input to the hardware device 206 via the second type of connection. The facility system device 204 can thereafter receive the indication associated with the input from the hardware device 206 via the first type of connection and change a configuration status of the facility system device 204 according to the indication. Changing the configuration status can include configuring the facility system device 204 in one or more manners as previously discussed.

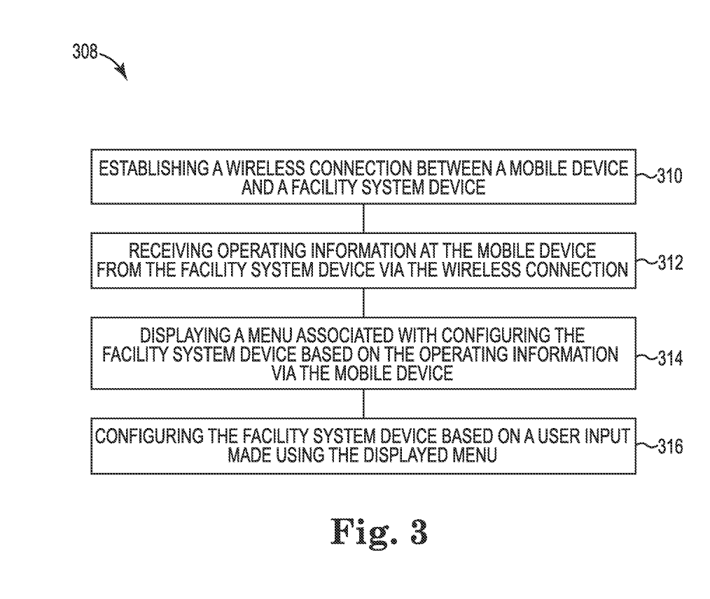

FIG. 3 illustrates a method 308 for configuring facility system device in accordance with one or more embodiments of the present disclosure. Method 308 can be performed, for example, by a computing device, such as mobile devices 102 and/or 202 previously described herein (e.g., in connection with FIGS. 1 and 2, respectively).

At block 310, method 308 includes establishing a wireless connection between a mobile device and a facility system device. A wireless connection can be established through the use of an NFC tag, for example, though embodiments of the present disclosure are not so limited. It is noted that because embodiments of the present disclosure can configure facility system devices via a wireless connection, in some examples, facility system devices can be configured without removing them from a shipping container (e.g., a box).

For example, under previous approaches, devices may be configured in a system integrator's office and then shipped to the facility for installation. In order to do so, the facility system device may need to be removed from its shipping container, powered (e.g., using a battery or live power), configured (e.g., using computing device(s), tool(s), button(s), etc.), then repacked and shipped to the facility. According to embodiments of the present disclosure, because the facility system device can be powered by an NFC tag, removing the device from its container may not be necessary for configuration.

At block 312, method 308 includes receiving operating information at the mobile device from the facility system device via the wireless connection. The operating information can include a status of the device (e.g., a configuration status) and/or supporting information, for instance.

At block 314, method 308 includes displaying a menu associated with configuring the facility system device based on the operating information via the mobile device. As previously discussed, the menu can include a number of options for configuring the facility system device, for instance.

At block 316, method 308 includes configuring the facility system device based on a user input made using the displayed menu. The inputs can be made using a keyboard and/or touchscreen keyboard of the mobile device, though embodiments of the present disclosure are not limited to a particular manner of making inputs. For example, in some embodiments, inputs may be made by voice using a microphone of the mobile device and speech recognition may be employed. As previously discussed, facility system devices may be configurable without removing them from a shipping container. That is, method 308 can include configuring the facility system device without removing the facility system device from a shipping container.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for configuring a facility system device, comprising:
establishing a wireless connection between a mobile device and a facility system device;
receiving operating information at the mobile device from the facility system device via the wireless connection;
displaying a menu associated with configuring the facility system device based on the operating information via the mobile device; and
configuring the facility system device based on a user input made using the displayed menu.

2. The method of claim 1, wherein the facility system device includes a near field communication tag.

3. The method of claim 2, wherein the near field communication tag is configured to activate and interrupt a controller of the facility system device responsive to receiving a signal from the mobile device.

4. The method of claim 1, wherein configuring the facility system device includes assigning an address to the facility system device.

5. The method of claim 1, wherein configuring the facility system device includes testing the facility system device.

6. The method of claim 1, wherein configuring the facility system device includes upgrading a firmware associated with the facility system device.

7. The method of claim 1, wherein the input is received via a display of the mobile device.

8. The method of claim 1, wherein the input is received via a voice command.

9. The method of claim 1, wherein the method includes:
determining a location of the facility system device;
determining a location of the mobile device; and
navigating a user of the mobile device to the facility system device.

10. The method of claim 1, wherein the method includes configuring the facility system device without removing the facility system device from a shipping container

11. A system for configuring a facility system device, comprising:
a facility system device; and
a mobile device, configured to:
establish a wireless connection with the facility system device;
receive operating information from the facility system device via the wireless connection;
provide the operating information to a user of the mobile device;
receive an input associated with configuring the facility system device; and
configure the facility system device based on the input.

12. The system of claim 11, wherein the mobile device is configured to:
provide the operating information to the user via a display of the mobile device; and
receive the input via at least one of: the display and an audio capturing functionality of the mobile device.

13. The system of claim 11, wherein the mobile device is configured to:
determine a status of a network associated with the facility system device based on the operating information;
display the determined status of the network; and
allow the user to take an action affecting the network using the mobile device.

14. The system of claim 11, wherein the mobile device is configured to receive the operating information from the facility system device via the wireless connection while the facility system device is not powered.

15. The system of claim 11, wherein the mobile device is configured to:
send a signal to a near field communication tag of the facility system device; and
receive the operating information via the wireless connection from a controller of the facility system device.

16. A system for configuring a facility system device, comprising:
a facility system device;
a hardware device configured to establish a first type of connection with the facility system device; and
a mobile device, configured to establish a second type of connection with the hardware device, wherein:
the hardware device is configured to receive operating information associated with the facility system device from the facility system device via the first type of connection;
the mobile device is configured to:
receive the operating information from the hardware device via the second type of connection;
receive an input, made by a user, associated with configuring the facility system device;
communicate an indication associated with the input to the hardware device via the second type of connection; and wherein
the facility system device is configured to receive the indication associated with the input from the hardware device via the first type of connection and change a configuration status of the facility system device according to the indication.

17. The system of claim 16, wherein the hardware device is a dongle.

18. The system of claim 16, wherein the hardware device is adapted to be removably attached to the facility system device.

19. The system of claim 16, wherein the hardware device and the facility system device each include a respective portion adapted to allow the hardware device to be removably attached to the facility system device.

20. The system of claim 16, wherein the hardware device is adapted to be attached to an object at a position proximal to the facility system device.
